(19) United States
(12) Patent Application Publication
(10) Pub. No.: US 2011/0142145 A1
(43) Pub. Date: Jun. 16, 2011

(54) METHOD FOR ESTIMATING FREQUENCY OFFSET IN ORTHOGONAL FREQUENCY DIVISION MULTIPLEXING SYSTEM

(75) Inventors: Hyungu HWANG, Daejeon (KR); Daeho KIM, Daejeon (KR); Jung Sook BAE, Daejeon (KR)

(73) Assignee: Electronics and Telecommunications Research Institute, Daejeon (KR)

(21) Appl. No.: 12/835,339

(22) Filed: Jul. 13, 2010

(30) Foreign Application Priority Data
Dec. 15, 2009 (KR) 10-2009-0124349

(51) Int. Cl. H04L 27/28

(52) U.S. Cl. 375/260; 375/343

(57) ABSTRACT

Provided is a method for estimating a frequency offset. The method for estimating the frequency offset may include calculating autocorrelation values associated with a Cyclic Prefix (CP) for a reception signal, dividing the calculated autocorrelation values into first autocorrelation values associated with an interval where a signal exists and second autocorrelation values associated with an interval where a signal does not exist, determining whether to use the divided second autocorrelation values; and estimating the frequency offset using the second autocorrelation values determined to be used and the first autocorrelation values.

### CROSS-REFERENCE TO RELATED APPLICATION

This application claims the benefit of Korean Patent Application No. 10-2009-0124349, filed on Dec. 15, 2009, in the Korean Intellectual Property Office, the disclosure of which is incorporated herein by reference.

### BACKGROUND

1. Field of the Invention

Embodiments of the present invention relate to a method for estimating a frequency offset in an Orthogonal Frequency Division Multiplexing (OFDM) system.

2. Description of the Related Art

In general, there exists a Cyclic Prefix (CP) in an Orthogonal Frequency Division Multiplexing (OFDM) system, a frequency offset may be estimated using the CP.

However, when the OFDM system performs a packet communication which is different from a circuit communication, the CP does not always exist. Specifically, a 3rd Generation Long Term Evolution (3G LTE) system may be included in the OFDM system. In the 3G LTE system where the packet communication is performed, there always exist signals in an OFDM symbol interval where a reference signal exists, however, there may not exist signals in the remaining symbol intervals excluding the OFDM symbol interval where the reference signal exists.

For example, as for a structure of a 1 ms sub-frame used in the 3G LTE system, there always exists reference signals in 0-th, fourth, seventh, and eleventh symbol intervals, and there may or may not exist signals in the remaining OFDM symbol intervals. In this case, a method of estimating a frequency offset may calculate an autocorrelation value using the CP only in a symbol interval where the CP always exists, and estimate the frequency offset using the calculated autocorrelation value.

A first conventional method of estimating the frequency offset may calculate the autocorrelation value only in symbol intervals where the CP exists, and estimate the frequency offset using the calculated autocorrelation value. A second conventional method of estimating the frequency offset may estimate the frequency offset always using the autocorrelation value under an assumption that a signal, that is, the CP, always exists regardless of actual presence/absence of signals.

However, the above two conventional methods may have problems in effectively estimating the frequency offset. In the first conventional method of performing an autocorrelation only in the symbol interval where the signal always exists, a performance may be deteriorated in a case where data actually exists in all symbol intervals, in comparison with the second conventional method.

FIG. 1 is a diagram illustrating a performance of an OFDM system that may perform a frequency offset estimation method according to a conventional art;

Referring to FIG. 1, a solid line including asterisks may signify a performance obtained based on the above described first conventional method, and a chain line including circles may signify a performance obtained based on the above second conventional method of a case where data exists in all symbol intervals.

Here, the performance as shown by the solid line may be deteriorated in comparison with the performance as shown by the chain line. This is because the first conventional method uses a smaller number of samples to estimate the frequency offset.

Also, as for the second conventional method where the autocorrelation value is always used for estimating the frequency offset under the assumption that the signal always exists, a performance may be deteriorated in a case where a signal does not exist a significant portion of times. This is because noise may be added in the symbol interval where the signal does not exist.

Also, a dotted line including triangles may signify a performance obtained based on the above second conventional method of a case where only a reference signal exists and a data signal does not exist. As illustrated in FIG. 1, the dotted line shows a significantly deteriorated performance, and thus the OFDM system may become unstable.

### SUMMARY

An aspect of the present invention provides a method for estimating a frequency offset in an Orthogonal Frequency Division Multiplexing (OFDM) system, which may calculate autocorrelation values associated with a Cyclic Prefix (CP) for a reception signal, and estimate the frequency offset using the autocorrelation values selected in accordance with an interval where a signal exists and an interval where a signal does not exist, from among the calculated autocorrelation values.

According to an aspect of the present invention, there is provided a method for estimating a frequency offset, the method including: calculating autocorrelation values associated with a Cyclic Prefix (CP) for a reception signal; dividing the calculated autocorrelation values into first autocorrelation values associated with an interval where a signal exists and second autocorrelation values associated with an interval where a signal does not exist; determining whether to use the divided second autocorrelation values; and estimating the frequency offset using the second autocorrelation values determined to be used and the first autocorrelation values.

Also, when an angle having a value of a complex number for the second autocorrelation value is included in a range between a predetermined lower threshold value and a predetermined higher threshold value, the determining may determine to use the second autocorrelation value.

Also, when a real number of a complex number for the second autocorrelation value exceeds a predetermined threshold value, the determining may determine to use the second autocorrelation value.

Also, the method may further include selecting the threshold value in proportion to an average of real numbers associated with the first autocorrelation values.

Additional aspects, features, and/or advantages of the invention will be set forth in part in the description which follows and, in part, will be apparent from the description, or may be learned by practice of the invention.

### EFFECT

According to an embodiment, it is possible to effectively estimate a frequency offset in an Orthogonal Frequency Division Multiplexing (OFDM) system.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a graph illustrating a performance of an OFDM system that may perform a frequency offset estimation method according to a conventional art;

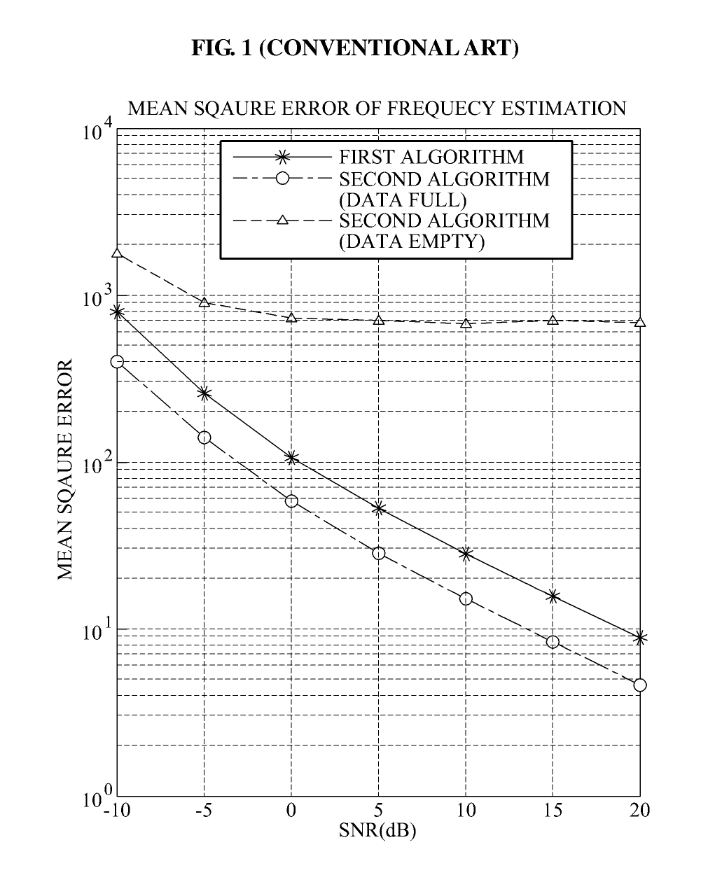

FIG. 2 is a flowchart illustrating a method for estimating a frequency offset according to an embodiment;

FIG. 3 is a diagram illustrating an example of a signal mechanism where a method for estimating a frequency offset according to an embodiment is adopted;

FIG. 4 is a graph illustrating a comparison between a performance of a conventional OFDM system and a performance of an OFDM system according to an embodiment; and

FIG. 5 is a block diagram illustrating a system for estimating a frequency offset according to an embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

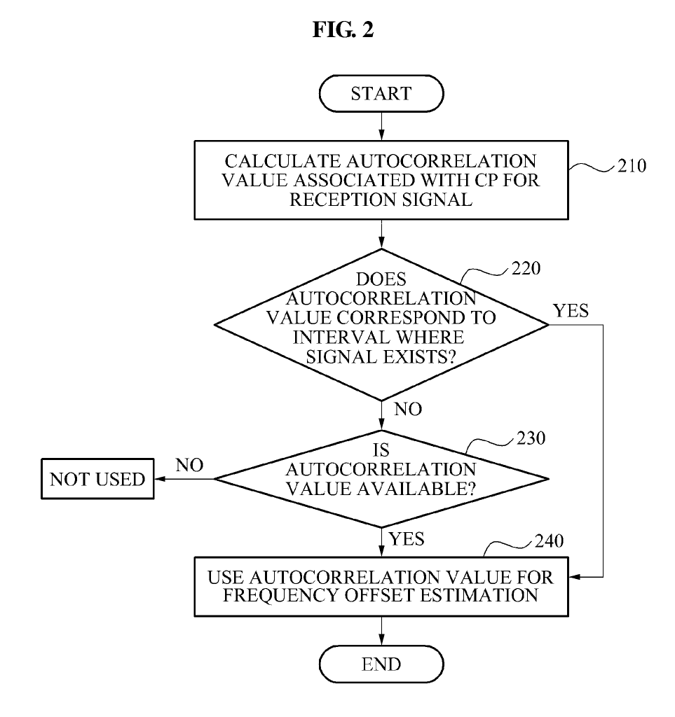

FIG. 2 is a flowchart illustrating a method for estimating a frequency offset according to an embodiment.

Referring to FIG. 2, in operation 210, the method may calculate an autocorrelation value associated with a Cyclic Prefix (CP) for a reception signal.

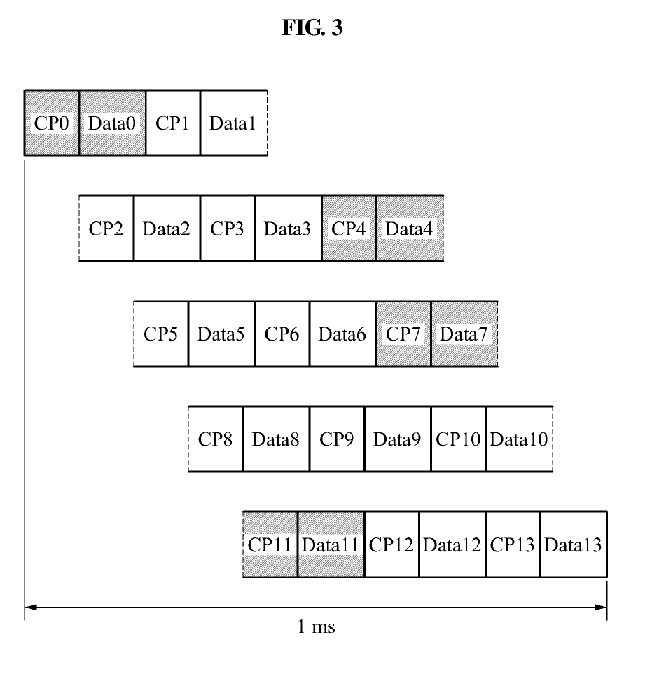

FIG. 3 is a diagram illustrating an example of a signal mechanism where a method for estimating a frequency offset according to an embodiment is adopted.

Referring to FIG. 3, a 1 ms sub-frame may be configured of a total number of 14 OFDM symbols ranging from 0 to 13. Here, a reference signal may always exist in 0-th, fourth, seventh, and eleventh OFDM symbols with a dark color, and a signal may or may not exist in the remaining OFDM symbols.

To receive a signal illustrated in FIG. 3 and to estimate a frequency offset, the method for estimating the frequency offset may obtain an autocorrelation value by performing an autocorrelation on a CP of each OFDM symbol and data associated with the CP. When the frequency offset does not exist, the obtained autocorrelation value may be a real number, and an imaginary number part may be ‘0’. However, when the frequency offset exists, the obtained autocorrelation value may be a complex number, and may be expressed as a vector having a size and angle on a complex number plane.

As described above, the obtained autocorrelation values may be classified into a ‘first autocorrelation value’ in a symbol interval where a signal always exists and a ‘second autocorrelation value’ in a symbol interval where a signal does not always exist. For example, referring to FIG. 3, first autocorrelation values calculated in 0-th, fourth, seventh, and eleventh OFDM symbol intervals where the signal always exists may be meaningful values, and may be used for estimating the frequency offset. However, second autocorrelation values calculated in the remaining OFDM symbol intervals where the signal does not always exist may be meaningful or meaningless depending on whether the signal is actually transmitted.

Accordingly, the method for estimating the frequency offset may determine whether to use the second autocorrelation values, calculated in the symbol interval where the signal does not always exist, for estimating the frequency offset.

Referring again to FIG. 2, in operation 220, the method for estimating the frequency offset may determine whether the calculated autocorrelation value is included in a symbol interval where the signal exists. Specifically, the first autocorrelation value of the symbol interval where the signal always exists, from among the calculated autocorrelation values, may be directly used for estimating the frequency offset, however, the second autocorrelation value of the symbol interval where the signal does not always exist may be determined to be available or not.

In operation 230, the method for estimating the frequency offset may determine whether the second autocorrelation value of the symbol interval where the signal does not always exist is available. Specifically, the method for estimating the frequency offset may determine whether the second autocorrelation value is useful for estimating the frequency offset. An algorithm of determining whether the second autocorrelation value is useful for estimating the frequency offset may be diversely provided as below.

According to an embodiment, a first algorithm may determine to use the second autocorrelation value when an angle having a value of a complex number for the second autocorrelation value is in a predetermined range. The predetermined range may signify a range between a predetermined lower threshold value and a predetermined upper threshold value.

For example, only when the angle having a value of the complex number for the second autocorrelation value is in a range of −10 degrees to 10 degrees, may the method for estimating the frequency offset use the second autocorrelation value. The second autocorrelation value may be used since the frequency offset is generally well corrected, and a magnitude of the frequency offset is close to 0 Hz so that the angle having a value of the complex number obtained as the autocorrelation value approaches 0 degrees. Accordingly, the autocorrelation value of the complex number that does not approach 0 degrees may be determined as noise, the autocorrelation value determined as noise may not be used for estimating the frequency offset.

A second algorithm may determine to use the second autocorrelation value when a magnitude of a real number of the complex number obtained as the second autocorrelation value exceeds a predetermined threshold value. The predetermined threshold value may be determined in proportion to an average of real numbers associated with the first autocorrelation values.

For example, the method for estimating the frequency offset may use the second autocorrelation value only when the magnitude of the real number of the complex number obtained as the second autocorrelation value exceeds 0.75*mag. Here, ‘mag’ denotes an average of real numbers of the first autocorrelation values calculated in the symbol interval where the signal always exists. The second autocorrelation value may be used since, in a process of calculating the autocorrelation value when the signal exists, respective autocorrelation signal samples may be added to be in the same phase to thereby generate a significantly large real number. The significantly large real number may denote a high probability that a signal does not exist in a relatively small real number.

The above described two algorithms may be used together. Specifically, the method for estimating the frequency offset may determine to use the second autocorrelation value when the angle having a value of the complex number calculated as the autocorrelation value is in the predetermined range, and at the same time the magnitude of the real number of the complex number exceeds the threshold value.

Referring again to FIG. 2, in operation 240, the method for estimating the frequency offset may estimate the frequency offset using the first autocorrelation value and the second autocorrelation values determined to be used. Specifically, the method for estimating the frequency offset may estimate the frequency offset using the first autocorrelation values calculated in the symbol interval where the signal always exists and using the second autocorrelation values determined to be used, from among the second autocorrelation values calculated in the symbol interval where the signal does not always exist.

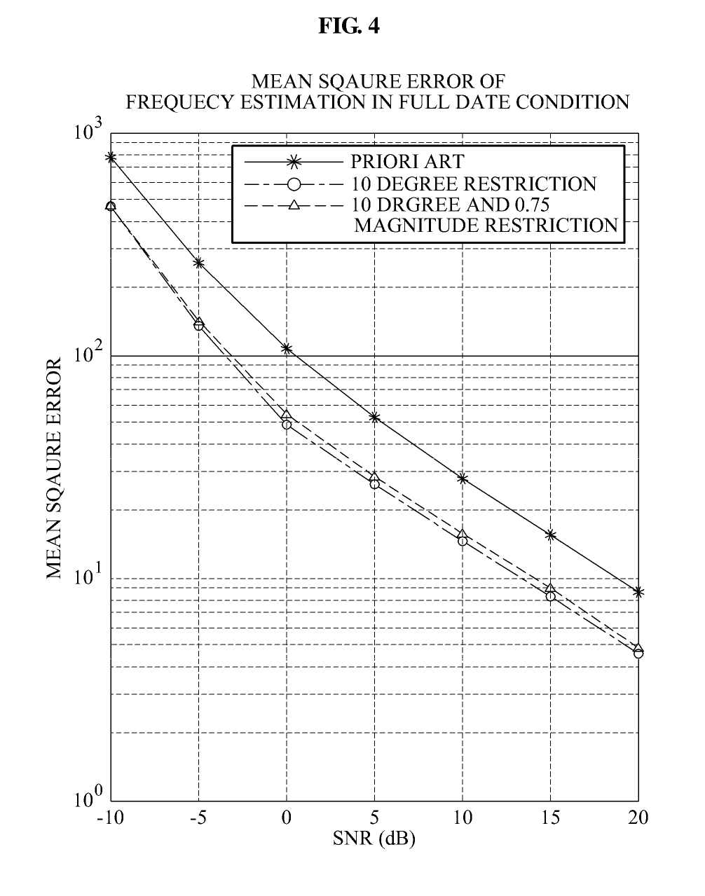

FIG. 4 is a graph illustrating a comparison between a performance of a conventional OFDM system and a performance of an OFDM system according to an embodiment.

Referring to FIG. 4, a solid line including asterisks may signify a performance obtained by estimating a frequency offset only using an autocorrelation value of a symbol interval where a signal always exist. Conversely, a chain line including circles may signify a performance obtained by estimating the frequency offset using the algorithm according to an embodiment, which may determine to use the second autocorrelation value when the angle having a value of the complex number calculated as the second autocorrelation value is in a range of −10 degrees to +10 degrees.

A dotted line including triangles may signify a performance obtained when the above described two algorithms are used together. Specifically, the dotted line may signify the performance obtained by estimating the frequency offset using the second autocorrelation value obtained when the angle having a value of the complex number for the second autocorrelation value is in the range of −10 degrees to +10 degrees, and at the same time the magnitude of the real number of the complex number calculated as the second autocorrelation value exceeds 0.75*mag.

The graph of FIG. 4 shows that the method for estimating the frequency offset according to an embodiment more effectively estimates the frequency offset in comparison with the conventional method for estimating the frequency offset.

Accordingly, the method for estimating the frequency offset in the OFDM system according to an embodiment may effectively perform a frequency offset estimation in a packet transmission system.

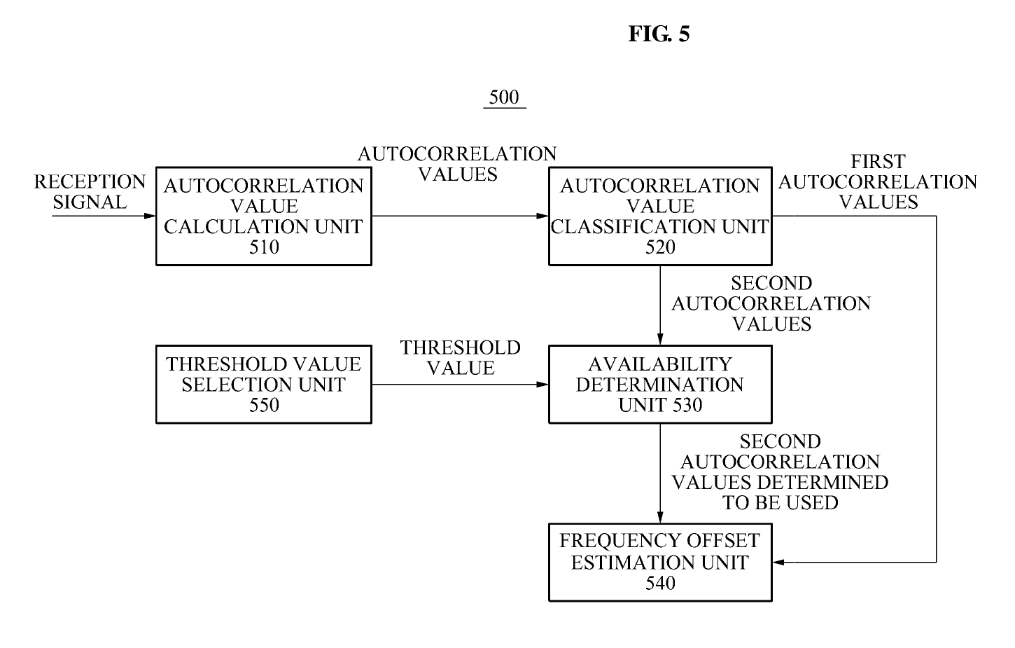

FIG. 5 is a block diagram illustrating a system 500 for estimating a frequency offset according to an embodiment.

Referring to FIG. 5, the system 500 includes an autocorrelation value calculation unit 510, an autocorrelation value classification unit 520, an availability determination unit 530, a frequency offset estimation unit 540, and a threshold value selection unit 550.

The autocorrelation value calculation unit 510 may calculate autocorrelation values associated with a CP for a reception signal. In this instance, the autocorrelation value calculation unit 510 may perform an autocorrelation on a CP of each OFDM symbol and data associated with the CP to thereby calculate the autocorrelation values.

The autocorrelation value classification unit 520 may classify the calculated autocorrelation values into first autocorrelation values associated with a symbol interval where a signal exists and second autocorrelation values associated with a symbol interval where a signal does not exist.

The availability determination unit 530 may determine availability of the second autocorrelation values.

According to an embodiment, the availability determination unit 530 may determine to use the second autocorrelation values when an angle having a value of a complex number with respect to the second autocorrelation value is in a range between a predetermined lower threshold value and a predetermined upper threshold value. For example, the availability determination unit 530 may determine to use the second autocorrelation value when the angle having a value of the complex number calculated as the second autocorrelation value is in a range of −10 degrees of the lower threshold value, to +10 degrees of the upper threshold value.

According to another embodiment, the availability determination unit 530 may determine to use the second autocorrelation value when a magnitude of a real number of the complex number for the second autocorrelation value exceeds a predetermined threshold value. Here, the threshold value selection unit 550 may select the threshold value in proportion to an average of real numbers associated with the first autocorrelation values. For example, the availability determination unit 530 may determine to use the second autocorrelation value when the magnitude of the real number of the complex number for the second autocorrelation value exceeds 0.75*mag, that is, the predetermined threshold value.

The frequency offset estimation unit 540 may estimate the frequency offset using the second autocorrelation values determined to be used, and the first autocorrelation values.

The methods according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for estimating a frequency offset, the method comprising:
calculating autocorrelation values associated with a Cyclic Prefix (CP) for a reception signal;
dividing the calculated autocorrelation values into first autocorrelation values associated with an interval where a signal exists and second autocorrelation values associated with an interval where a signal does not exist;
determining whether to use the divided second autocorrelation values; and
estimating the frequency offset using the second autocorrelation values determined to be used and the first autocorrelation values.

2. The method of claim 1, wherein, when an angle having a value of a complex number for the second autocorrelation value is included in a range between a predetermined lower threshold value and a predetermined higher threshold value, the determining determines to use the second autocorrelation value.

3. The method of claim 1, wherein, when a real number of a complex number for the second autocorrelation value exceeds a predetermined threshold value, the determining determines to use the second autocorrelation value.

4. The method of claim 3, further comprising:
selecting the threshold value in proportion to an average of real numbers associated with the first autocorrelation values.
